(19) United States
(12) Patent Application Publication
(10) Pub. No.: US 2010/0329535 A1
(43) Pub. Date: Dec. 30, 2010

(54) Methods, Systems and Computer Program Products for Analyzing Histology Slide Images

(76) Inventors: Marc Macenko, Durham, NC (US); Marc Niethammer, Carrboro, NC (US); James S. Marron, Durham, NC (US); Nancy Thomas, Durham, NC (US)

Correspondence Address: MYERS BIGEL SIBLEY & SAJOVEC, PO BOX 37428, RALEIGH, NC, 27627, US

(21) Appl. No.: 12/823,372

(22) Filed: Jun. 25, 2010

Related U.S. Application Data
(60) Provisional application No. 61/269,566, filed on Jun. 26, 2009.

(51) Int. Cl. G06K 9/00

(52) U.S. Cl. 382/133

(57) ABSTRACT

Methods, systems and computer program products for normalizing histology slide images are provided. A color vector for pixels of the histology slide images is determined. An intensity profile of a stain for the pixels of the histology slide images is normalized. Normalized image data of the histology slide images is provided including the color vector and the normalized intensity profile of a stain for the pixels of the histology slide images.

### RELATED APPLICATIONS

This applications claims priority to U.S. Provisional Application Ser. No. 61/269,566, filed Jun. 26, 2009, the disclosure of which is hereby incorporated by reference in its entirety.

### FIELD OF THE INVENTION

The present invention relates to histology slide images, and in particular, to methods, systems, and computer program products for analyzing and normalizing color vectors and color intensity data of histology slide images.

### BACKGROUND

In many biological fields, tissue samples are taken from a subject for analysis. One common way of analyzing the tissue sample is to treat it with stains that have selective affinities for different biological substances. The majority of stains only absorb light, and the stained slides are therefore viewed using a microscope with a light illuminating the sample from below. If no stain is present, all of the light will pass through, appearing bright white. Areas where the stain has adhered to a substance in the tissue will absorb some of the light. The amount of light absorbed depends on many factors. For a given unit of stain, a certain amount of light in each spectrum will be absorbed. In the case of multispectral imaging, this process can be quite complicated. For example, standard 24-bit red-green-blue (RGB) cameras can be used to obtain images in the three wavelengths (red-green-blue) of light. The proportion of each wavelength absorbed forms the stain vector. The stain vector not only varies greatly among different stains but can also vary significantly for the same stain depending on such factors as the manufacturer, the storage conditions prior to use, and the method of application.

The overall amount of light absorbed also varies between slides prepared differently. The two most prominent factors that affect the intensity of a slide are the relative amounts of stain added in the original treatment and the subsequent storage and handling of the slide, as stains can fade when exposed to light. The amount of light absorbed is referred to as the stain intensity.

The absolute color values of a slide have many influences, and generally only one of the influences is the biological component, i.e., the actual amount of the cellular substance to which a particular stain will attach. For example, in the most popular staining method for medical diagnosis, hematoxylin selectively stains nucleic acids a blue-purple hue while eosin stains proteins a bright pink color. Other variations result from staining compounds that do not absorb the exact same amounts of light, therefore exhibiting slightly different colors.

Most current applications for analyzing the images concentrate on shape features and are thus not affected by the color irregularities between various slides except when it interferes with segmentation on which the shape features are based. When color information is utilized, the raw color values obtained from the scanner can be used. This approach adds some information, but differences in staining are not taken into account.

### SUMMARY OF EMBODIMENTS OF THE INVENTION

Methods, systems and computer program products for normalizing histology slide images are provided. A color vector for pixels of the histology slide images is determined. An intensity profile of a stain for the pixels of the histology slide images is normalized. Normalized image data of the histology slide images is provided including the color vector and the normalized intensity profile of a stain for the pixels of the histology slide images.

### BRIEF DESCRIPTION OF THE DRAWINGS

The accompanying drawings, which are incorporated in and constitute a part of the specification, illustrate embodiments of the invention and, together with the description, serve to explain principles of the invention.

FIGS. 1 and 2A-2B are flowcharts illustrating operations according to some embodiments of the present invention.

FIG. 3 is a block diagram illustrating systems according to some embodiments of the invention.

FIG. 4 is a digital image of two histopathology slides of melanomas, both stained with hematoxylin and eosin. The images have different appearances due to processing variations.

FIG. 5A is a three-dimensional graph illustrating a three-dimensional red-green-blue color space for pixels in a histology image according to some embodiments of the invention. The colors may be separated along a curve as indicated.

FIG. 5B is a three-dimensional graph illustrating the pixels of FIG. 5A transformed into the optical density (OD) space according to some embodiments of the invention. The colors may be separated via a straight-line from the origin as indicated.

FIG. 6A is a graph illustrating contours of a pixel histogram in which the ridge line is calculated by singular value decomposition (SPD) according to some embodiments of the invention, which results in a geodesic on the sphere that is overlaid in black.

FIG. 6B is a graph of the histogram of angles that the points form with a geodesic line shown in FIG. 6A such that the color corresponds to the pixel color that would contribute to that bin according to some embodiments of the invention.

FIG. 7 is a graph of a calculated stain vectors for 12 hematoxylin and eosin stained test slides according to some embodiments of the invention. The color of each symbol corresponds to what would be produced by that vector. The stars are the standard vectors used without regard to the specific slide. The circles are the automatically computed stain vectors. All recovered vectors are significantly different from the standard vectors.

FIG. 8 is a digital image illustrating the result of deconvolution the automatically determined stain vectors according to some embodiments of the invention. The top left image is the original image. The bottom two images are a separation into the two stains. The top right image shows the values orthogonal to the plane created by the two stain vectors and includes pigmentation and noise. The fact that this image is nearly empty is evidence that the stain vectors were well-chosen.

FIG. 9 is a graph of the frequency as a function of OD intensity for a histogram of pixel saturation values according to some embodiments of the invention. The top black line includes all values, and the bottom two colored histograms correspond to the respective stains. The saturation of the color corresponds to the saturation of the pixels that correspond to that histogram bin.

FIG. 10 is a digital image corresponding to the digital images of FIG. 4 in which the second slide has been transformed into the same color space is the first slide according to some embodiments of the invention to correct/normalize color vectors.

FIG. 11 is a digital image using the same images of FIG. 10 in which the intensities of the slides have been normalized according to some embodiments of the invention.

FIGS. 12A-12B are graphs of the distance weighted cell-by-cell discrimination of melanomas from benign nevi (moles). FIG. 12A is before the color vector and intensity corrections, and there is significant overlap between the melanoma and nevus cells. FIG. 12B is the same data after the color vector and intensity corrections, and the overlap between the melanoma and nevus cells is reduced.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain or store the program for use by or in connection with the instruction execution system, apparatus, or device.

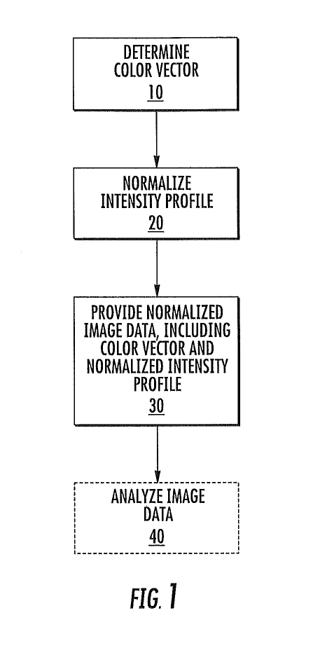

As illustrated in FIG. 1, operations according to some embodiments of the present invention include determining a color vector for pixels of histology slide images (Block 10). For example, the color vector can be selected such that each pixel is a linear combination of two or more stain vectors. An intensity profile for a stain for the pixels of the histology slide is normalized (Block 20). Normalized image data of the histology slide images are provided, including the color vector and the normalized intensity profile of a stain for the pixels of the histology slide images (Block 30). The normalized image data can then be analyzed using quantitative techniques to determine, for example, pathologies in the tissue such as cancer (melanoma) (Block 40). Quantitative techniques include sub-typing diseases and/or or grading the severity of diseases (such as cancer), or any technique for assessing features related to patient outcome.

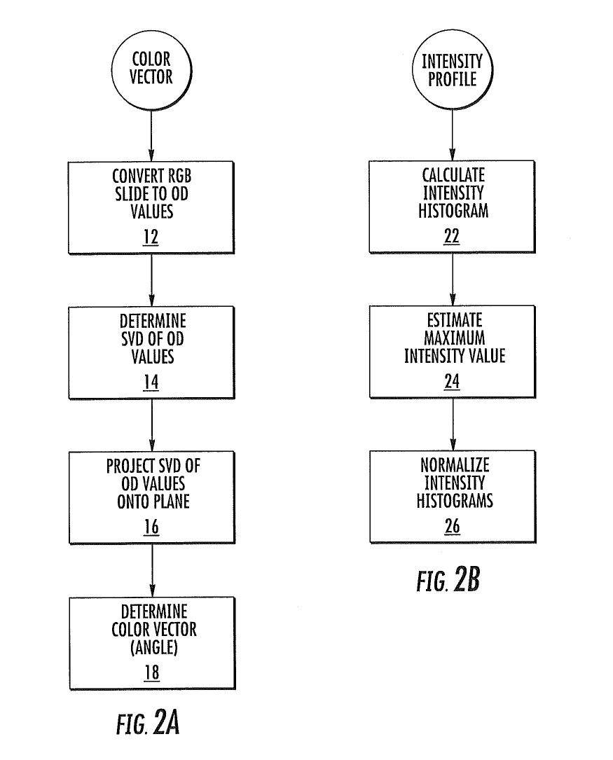

As shown in FIG. 2A, the step of determining a color vector for pixels of the histology slide images can include converting pixels of a red-green-blue (RGB) histology slide to corresponding optical density (OD) values (Block 12). A singular value decomposition (SVD) of the OD values is determined (Block 14). The SVD of the OD values are projected onto a plane defined by two vectors corresponding to the two largest singular values of the SVD of the OD values (Block 16). An angle for each pixel of the histology slide is determined based on the SVD of the OD values projected onto the plane (Block 18).

Exemplary techniques for determining and/or correcting color vectors for pixels of the histology slide images are discussed in the Example section below.

As shown in FIG. 2B, the intensity profile of a stain can be normalized by calculating intensity histograms for pixels having a majority of a selected stain (Block 22). A maximum intensity for the histology slide images is estimated (e.g., the 99^{th} percentile of the intensity values) (Block 24). The intensity histograms are then normalized or scaled to have the same pseudo-maximum (Block 26).

Exemplary techniques for normalizing and/or correcting intensity variations are discussed in the Example section below.

As illustrated in FIG. 3, a data processing system includes a processor 110, and is in communication with the histology slide imaging system 120. The processor 110 communicates with the memory 114 via an address/data bus 148. The processor 110 can be any commercially available or custom microprocessor. The memory 114 is representative of the overall hierarchy of memory devices containing the software and data used to implement the functionality of the data processing system 100. The memory 114 can include, but is not limited to, the following types of devices: cache, ROM, PROM, EPROM, EEPROM, flash memory, SRAM, and DRAM.

As shown in FIG. 3, the memory 114 may include several categories of software and data used in the data processing system: the application programs 140, the operating system 142; the input/output (I/O) device drivers 148; and the data 146. The application programs 140 can include an histology slide normalization module 150 and/or a feature analysis module 152. The data 146 may include histology slide imaging data 160 (which can include histology slide images from the histology slide imaging system 120). Histology slide images can be obtained using techniques known to those of skill in the art. The histology slide normalization module 150 can be configured to carry out the operations discussed in FIGS. 1-2.

As will be appreciated by those of skill in the art, the operating system 152 shown in FIG. 3 may be any operating system suitable for use with a data processing system, such as OS/2, AIX, OS/390 or System390 from International Business Machines Corporation, Armonk, N.Y., Windows CE, Windows NT, Windows95, Windows98, Windows2000 or WindowsXP from Microsoft Corporation, Redmond, Wash., Unix or Linux or FreeBSD, Mac OS from Apple Computer, or proprietary operating systems. The I/O device drivers 148 typically include software routines accessed through the operating system 142 by the application programs 144 to communicate with devices such as I/O data port(s), data 146 and certain components of the memory 114 and/or the histology slide imaging system 120. The application programs 140 are illustrative of the programs that implement the various features of the data processing system 100 and can include at least one application which supports operations according to embodiments of the present invention. Finally, the data 140 represents the static and dynamic data used by the application programs 140, the operating system 142, the I/O device drivers 148, and other software programs that may reside in the memory 114.

While the present invention is illustrated, for example, with reference to the histology slide normalization module 150 and the feature analysis module 152 being an application program in FIG. 3, as will be appreciated by those of skill in the art, other configurations may also be utilized according to embodiments of the present invention. For example, the histology slide normalization module 150 may also be incorporated into the operating system 142, the I/O device drivers 148 or other such logical division of the data processing system 100. Thus, the present invention should not be construed as limited to the configuration of FIG. 3, which is intended to encompass any configuration capable of carrying out the operations described herein.

The I/O data port can be used to transfer information between the data processing system 100 and the histology slide imaging system 120 or another computer system or a network (e.g., the Internet) or to other devices controlled by the processor. These components may be conventional components such as those used in many conventional data processing systems that may be configured in accordance with the present invention to operate as described herein. Therefore, the histology slide normalization module 150 can be used to analyze histology slide imaging data 160 that has been previously collected and/or data 160 that is collected from the histology slide imaging system 120. The histology slide imaging system 120 can be a scanning system, e.g., the Aperio Scanscope® (Arperio Technologies, Inc., Vista, Calif.). The feature analysis module 152 can be used to analyze features in the histology slide images, for example, using the normalized image data provided by the histology slide normalization module 150 to detect pathologies in the histology slide images.

Although embodiments according to the present invention are described herein with respect to two stains for detecting melanoma, it should be understood that three or more stains can be used and/or other suitable types of histology slides can be used. Moreover, any suitable staining technique can be used. For example, the slides could be stained with any combination of two or three or more stains including hematoxylin, eosin, Periodic acid Schiff, and/or immunohistochemistry stains (such as MART-1)

Embodiments according to the present invention will now be described with respect to the following non-limiting examples.

### EXAMPLES

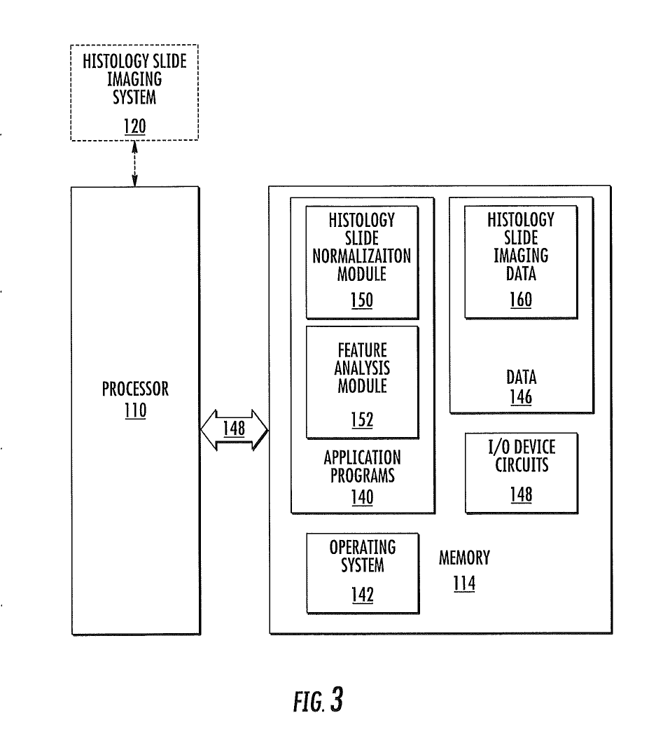

FIG. 4 shows two examples of skin histology slides treated at different times in different laboratories. The color and appearance of the slide images are different due to variables in processing techniques and storage. The absolute color values of a slide have many influences, only one of which is the biological component. The biological component is the actual amount of the cellular substance to which a particular stain will attach. The following techniques are used to normalize the slide images, which can isolate the biological component for further image analysis.

The red-green-blue color values are converted to their corresponding optical density (OD) values

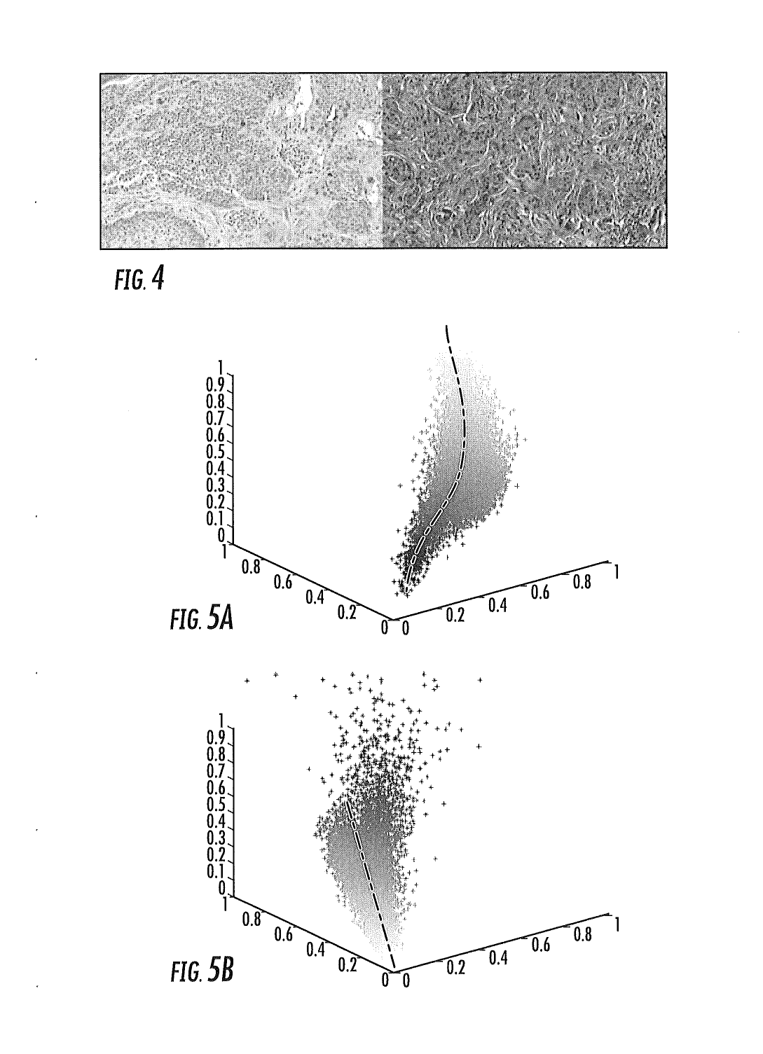

OD=−log₁₀ (I)
where I is the RGB color vector with each component normalized to [0;1]. This transformation provides a space where a linear combination of stains will result in a linear combination of OD values. The relationship between intensity and OD is demonstrated in FIGS. 5A-5B, using data acquired from images of hematoxylin and eosin stained melanoma slides.

Once the correct vectors are determined, e.g., as described herein, a simple color deconvolution scheme is used to transform the color values into quantitative values of interest:

OD=VS

[symbol]

S=V⁻¹OD
where OD is the optical density value observed and V and S are the matrices of the stain vectors and the saturations of each of the stains, respectively.

Stain Vector Variation and Correction

Slide preparation can vary widely due to different stain manufacturers, different staining procedures, and different storage times. It is assumed that there is a specific stain vector corresponding to each of the two stains present in the image, and that the resulting color (in OD space) of every pixel is a linear combination of these stain vectors. Since there is a non-negative weight on each component, every value generally exists between the two stain vectors. Accordingly, the techniques described herein can locate the fringe of the pixel distribution rather than searching for peaks. If noise were not a factor, the minimum and maximum along the identified direction may be used. Instead, robust versions of the minimum and maximum are used by taking the α^{th} and the (100−α)^{th} percentile. Empirically, α=1 provides robust results.

The following techniques can be used to identify the particular stain vectors for each image based on the colors that are present. An OD value of zero (0) corresponds to a pixel that is all white and essentially nothing on the slide absorbed any light. For stability reasons, the pixels with nearly no stain (low OD) were thresholded. After empirical analysis, a threshold value of β=0.15 was found to provide robust results while removing a relatively small amount of data. Acceptable results are achieved for a wide range of both α and β. For example, α can range between 0 and 50, where the value 50 would result in the median value.

The shortest path between two unit-norm color vectors on the sphere is the geodesic path. This line appears to be curved in a spherical coordinate decomposition unless it would correspond to change in only one direction or the other. By finding this specific geodesic direction, the OD transformed pixels can be projected onto it in order to find the endpoints that correspond to the stain vectors.

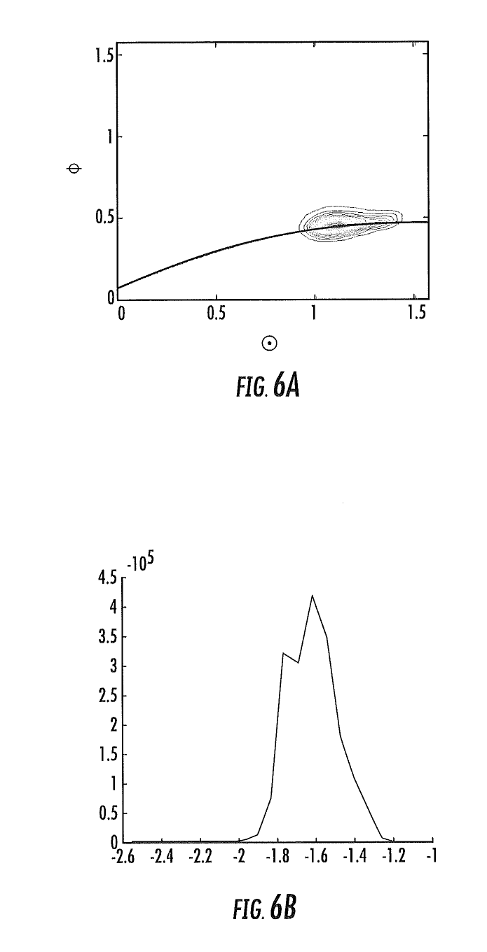

The first step in this process is to calculate the plane that the vectors form. This is done by forming a plane from the two vectors corresponding to the two largest singular values of the SVD decomposition of the OD transformed pixels. All of these OD transformed pixels are then projected onto this plane, and subsequently normalized to unit length. The projection line is shown to be curved in FIG. 6A. The angle with respect to the first SVD direction is calculated for each point, thus mapping the directions in the plane to a scalar. The histogram of these angles is shown in FIG. 6B.

The steps are summarized as follows: 1) the RGB slide is converted to the OD; 2) data with an OD intensity of less than β is removed; 3) the SVD of the OD tuples is calculated; 4) a plane is created from the SVD directions corresponding to the two largest singular values; 5) data is projected onto the plane and normalized to unit length; 6) an angle of each point with respect to the first SVD direction is calculated; 7) robust extremes (α^{th} and (100−α)^{th} percentiles) of the angle are identified; and 8) the extreme values are converted to OD space.

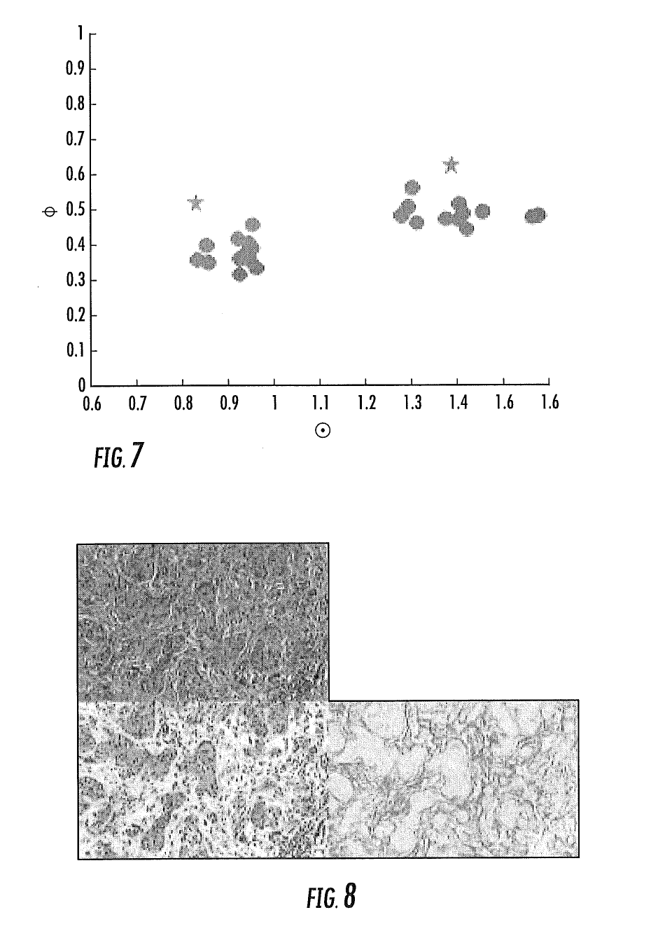

This method was performed on twelve different slides with some variation. Before the use of this method, standard vectors were computed using manual methods to select an area on the slide that only contains one stain and then to calculate an average stain vector from the area to identify vectors that could adequately describe all twelve slides. The results of these computations, along with the standard vectors, are shown in FIG. 7 where the color of each symbol corresponds to what would be produced by that vector. The stars are the standard vectors used without regard to the specific slide. The circles are the stains automatically generated with the techniques described herein. Notice that all the recovered stain vectors form tight clusters. While not completely coinciding with the stain vectors chosen manually (which is expected, since they were chosen as a compromise to represent all twelve slides simultaneously), stain vectors are similar, yet distinct for each of the slides, showing the need for repeatable automatic methods.

FIG. 8 shows the results of deconvolving with the automatically determined stain vectors. The top left image is the original image. The two bottom images show a good separation into the two stains. The top right image shows the values orthogonal to the plane created by the two stain vectors and includes pigmentation and noise. The fact that this image is nearly empty is evidence that the stain vectors were well chosen.

Intensity Variation and Correction

The intensity of a particular stain depends on the original strength of the stain, how much of it was applied to the tissue during the staining procedure, how much bleaching has occurred since the sample was originally processed, and finally how much of the reactive protein is present in the material.

The intensity of a particular stain depends on the original strength of the stain, the staining procedure, how much fading has occurred since the sample was originally processed, and finally how much of the cellular substance of interest is present in the material. The last quantity is what we actually want to measure. Removing the confounding factors that degrade the signal is necessary for direct analytical analysis of these samples.

An assumption can be made that the amount of protein or nucleic acid is a random variable that is scaled by the confounding factors mentioned previously. For each stain in question, the intensity histograms for all pixels that have a majority of that stain is calculated. The 99^{th} percentile of these intensity values is identified and used as a robust approximation of the maximum. This value was shown experimentally to be a good simple descriptor of the histogram by analyzing several patches of each slide; however, other values can be used. All intensity histograms are then scaled to have the same pseudo-maximum and are then able to be compared with each other.

As can be seen from FIG. 9, each stain has its own distribution, which is to be expected from the previously described theory. Fading affects are assumed to affect each stain identically, and that the only difference is the amount of stain added. The effects of fading can be further studied to investigate whether this is a correct assumption or whether a correction can be made.

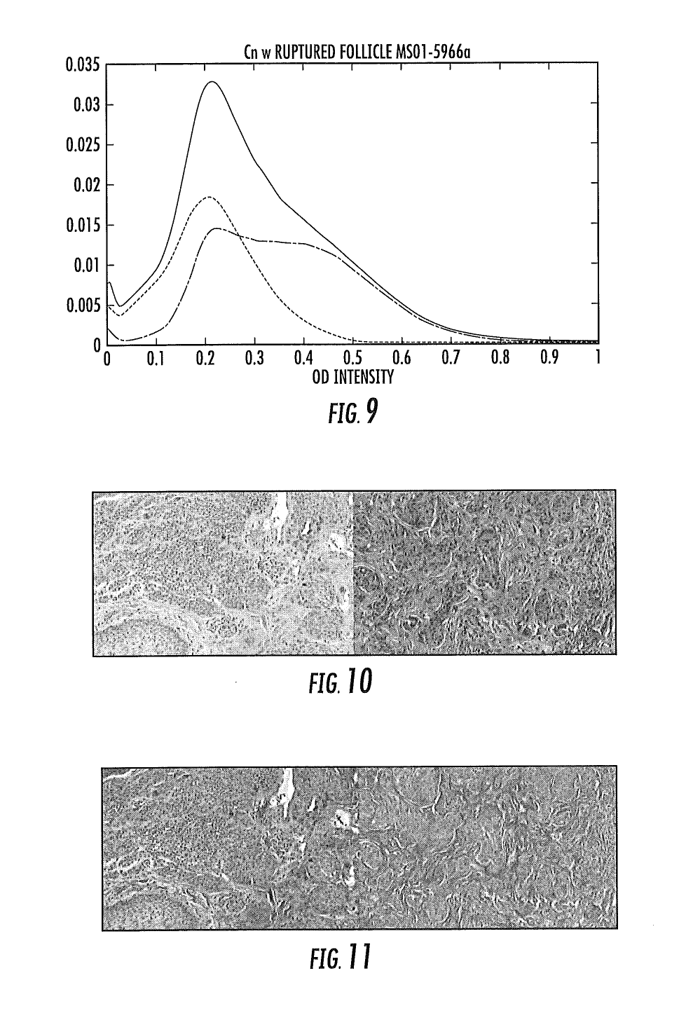

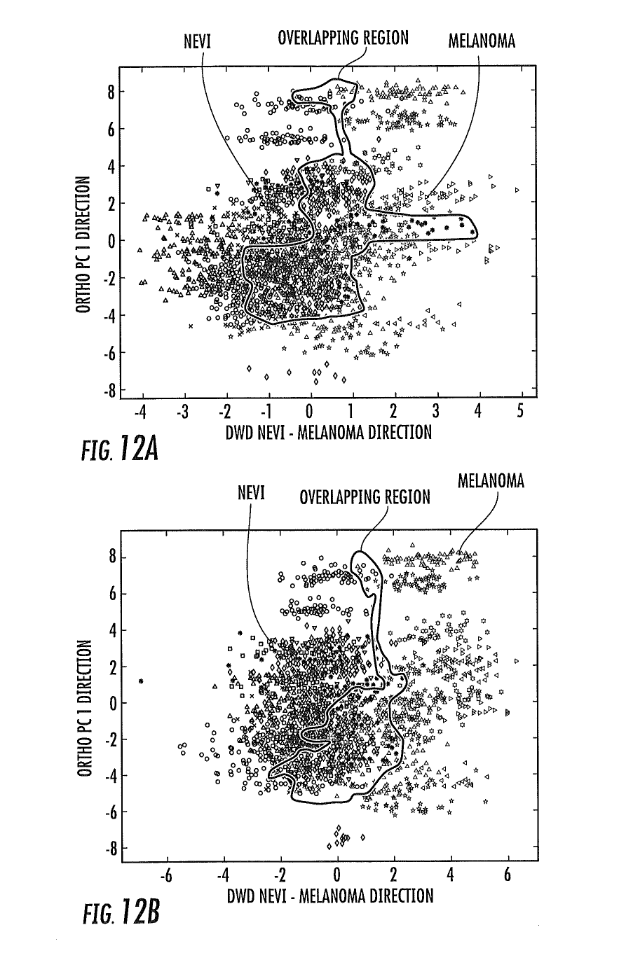

FIG. 10 shows an example where the images from FIG. 4 were transformed into the same colorspace by the method discussed in herein to correct stain/color vectors. Visually, they appear quite different, but to the stain quantization techniques and subsequent statistical analysis, there is a strong beneficial effect. FIG. 11 shows the images from FIG. 10, but both are now at the same average intensity level by using the method discussed in herein to correct intensity variation. This correction also leads to a much improved visual consistency of the two slides.

Analysis of five slides diagnosed with melanoma and seven slides containing benign nevi (common moles) was performed using a variety of shape and stain-based features. The slides had all been stained with hematoxylin and eosin and scanned at 20×. For each slide, a large number of nuclei are segmented and features calculated for each of them. The statistical method known as Distance Weighted Discrimination (DWD) (J S Marron, M J Todd, and J Ahn, “Distance weighted discrimination,” in J. of the Am. Statistical Assoc., 2007, vol. 102, pp. 1267-1271) was used to find the optimal separation direction between melanoma and nevi based on this feature-space. FIG. 12A shows a graphical representation of where the values from individual slides without correction are located on this DWD direction. There is clearly a difference between melanoma and nevi, but there is a large overlapping region. FIG. 12B shows the same results after being corrected with the methods described to correct for both color vector and intensity, and the increased separation of the groups is evident.

While the examples described herein have been performed using hematoxylin and eosin stained slides of melanomas and nevi, it should be understood that similar techniques applicable to other histologic stains and tissues. The techniques for obtaining the optimal stain vectors have been evaluated on slides with various stain combinations satisfactorily. When three or more stains are present in a slide, the results are sometimes inconsistent.

The techniques described herein have greatly improved the ability to quantitatively analyze histology slides and have improved the results of our investigations. Automating the process can accommodate larger datasets and enable a level of reproducibility not guaranteed with manual selection methods. The methods presented are easy to implement, and computation time is much improved over the non-negative matrix factorization (NMF) methods (A Rabinovich, S Agarwal, C A Laris, J H Price, and S Belongie, “Unsupervised color decomposition of histologically stained tissue samples,” in Adv. In Neural Inf. Proc. Systems, 2003). Embodiments according to the present invention may be applied additional research into medical aspects that use stained histology slides for diagnosis, prognosis or basic research, including immunohistochemistry staining of tissue and/or techniques for diagnosing disease in other types of images.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A system for normalizing histology slide images, the system comprising:
a histology slide image normalization module configured to (a) determine a color vector for pixels of the histology slide images; (b) normalize an intensity profile of a stain for the pixels of the histology slide images; and (c) provide normalized image data of the histology slide images comprising the color vector and the normalized intensity profile of a stain for the pixels of the histology slide images.

2. The system of claim 1, wherein the histology slide normalization module is configured to determine a color vector for pixels of the histology slide images by (d) converting pixels of a red-green-blue (RGB) histology slide to corresponding optical density (OD) values; (e) determining a singular value decomposition (SVD) of the optical density (OD) values; (f) projecting the singular value decomposition (SVD) of the optical density (OD) values onto a plane defined by two vectors corresponding to two largest singular values of the singular value decomposition (SVD) of the optical density (OD) values; and (g) determining an angle for each pixel of the histology slide based on the singular value decomposition (SVD) of the optical density (OD) values projected onto the plane.

3. The system of claim 1, wherein the histology slide normalization module is configure to normalize an intensity profile of a stain for the pixels of the histology slides by (h) determining an intensity histogram for the pixels having a majority of a selected stain; (i) estimating a maximum intensity for the histology slide images is estimated; and (j) scaling the intensity histograms to have the same maximum intensity.

4. The system of claim 3, wherein the estimated maximum intensity is the 99th percentile of the intensity values for the histology slide images.

5. The system of claim 3, wherein the histology slide normalization module is configured to define pixels having an optical density (OD) value below a threshold value as having an intensity of zero.

6. The system of claim 5, wherein the threshold value is under 0.15.

7. The system of claim 2, wherein the histology slide normalization module is configured to convert the normalized intensity histogram and the angle for each pixel of the histology slide to optical density (OD) values.

8. The system of claim 2, wherein the histology slide normalization module is configured to convert pixels of a red-green-blue (RGB) histology slide to corresponding optical density (OD) values, such that
OD=−log₁₀ (I)
wherein I is the RGB color vector with each component normalized to [0,1].

9. The method of claim 2, wherein the histology slide normalization module is configured to calculate a singular value decomposition (SVD) of the optical density (OD) values such that
OD=VS [symbol]
S=V⁻¹OD
wherein OD is the optical density value observed, V is a matrix of the stain vectors, and S is the matrix of the saturations.

10. The system of claim 1, further comprising a feature analysis module configured to detect pathologies in the histology slide images based on the normalized image data.

11. A method of normalizing histology slide images, the method comprising:
(a) determining a color vector for pixels of the histology slide images;
(b) normalizing an intensity profile of a stain for the pixels of the histology slide images; and
(c) providing normalized image data of the histology slide images comprising the color vector and the normalized intensity profile of a stain for the pixels of the histology slide images.

12. The method of claim 11, wherein (a) determining a color vector for pixels of the histology slide images comprises:
(d) converting pixels of a red-green-blue (RGB) histology slide to corresponding optical density (OD) values;
(e) determining a singular value decomposition (SVD) of the optical density (OD) values;
(f) projecting the singular value decomposition (SVD) of the optical density (OD) values onto a plane defined by two vectors corresponding to two largest singular values of the singular value decomposition (SVD) of the optical density (OD) values; and
(g) determining an angle for each pixel of the histology slide based on the singular value decomposition (SVD) of the optical density (OD) values projected onto the plane.

13. The method of claim 11, wherein (b) normalizing an intensity profile of a stain for the pixels of the histology slide images comprises:
(h) determining an intensity histogram for the pixels having a majority of a selected stain;
(i) estimating a maximum intensity for the histology slide images is estimated; and
(j) scaling the intensity histograms to have the same maximum intensity.

14. The method of claim 13, wherein the estimated maximum intensity is the 99th percentile of the intensity values for the histology slide images.

15. The method of claim 13, further comprising defining pixels having an optical density (OD) value below a threshold value as having an intensity of zero.

16. The method of claim 15, wherein the threshold value is under 0.15.

17. The method of claim 2, further comprising converting the normalized intensity histogram and the angle for each pixel of the histology slide to optical density (OD) values.

18. The method of claim 12, wherein (d) comprises converting pixels of a red-green-blue (RGB) histology slide to corresponding optical density (OD) values, such that
OD=−log₁₀ (I)
wherein I is the RGB color vector with each component normalized to [0,1].

19. The method of claim 12, wherein step (e) comprises calculating a singular value decomposition (SVD) of the optical density (OD) values such that
OD=VS [symbol]
S=V^{31 1}OD
wherein OD is the optical density value observed, V is a matrix of the stain vectors, and S is the matrix of the saturations.

20. The method of claim 11, further comprising detecting pathologies in the histology slide images based on the normalized image data.

21. A computer program product for normalizing histology slide images, the computer program product comprising a computer readable media having computer readable program code embodied therein, the computer readable program code comprising:
(a) computer readable program code configured to determine a color vector for pixels of the histology slide images;
(b) computer readable program code configured to normalize an intensity profile of a stain for the pixels of the histology slide images; and
(c) computer readable program code configured to provide normalized image data of the histology slide images comprising the color vector and the normalized intensity profile of a stain for the pixels of the histology slide images.
